(19) United States
(12) Patent Application Publication
(10) Pub. No.: US 2023/0298319 A1
(43) Pub. Date: Sep. 21, 2023

(54) VEHICLE STATE VERIFICATION

(71) Applicant: Parked Solutions, Inc., New Rochelle, NY (US)

(72) Inventors: Elan Nyer, Modi'in (IL); Dotan Raz, Netanya (IL); Sumit Mishra, Bangalore (IN)

(21) Appl. No.: 17/973,535

(22) Filed: Oct. 25, 2022

Related U.S. Application Data
(60) Provisional application No. 63/271,667, filed on Oct. 25, 2021.

(51) Int. Cl. G06V 10/70; G06V 20/59; G06V 20/62

(52) U.S. Cl. CPC G06V 10/768; G06V 20/59; G06V 20/625

(57) ABSTRACT

Systems and methods are disclosed for vehicle state verification. In one implementation, one or more first images are received. The one or more first images are processed to determine one or more aspects of an exterior of a vehicle. One or more second images are received. The one or more second images are processed to determine one or more aspects of an interior of the vehicle. The determined one or more aspects of the interior of the vehicle are validated with respect to the determined one or more aspects of the exterior of a vehicle. One or more operations are initiated based on the validation.

### CROSS-REFERENCE TO RELATED APPLICATION

This application is related to and claims the benefit of priority to U.S. Patent Application No. 63/271,667, filed Oct. 25, 2021, which is incorporated herein by reference in its entirety.

### TECHNICAL FIELD

Aspects and implementations of the present disclosure relate to data processing and, more specifically, but without limitation, to vehicle state verification.

### BACKGROUND

Many aspects of the use of a vehicle cannot be independently verified at regular intervals without implementing complex telematics solutions that are expensive, intrusive, and undesirable for many users.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIGS. 2A-2B depict example user interfaces in accordance with various embodiments.

FIGS. 3A-3B depict example user interfaces in accordance with various embodiments.

FIGS. 4A-4C depict example user interfaces in accordance with various embodiments.

FIG. 5 is a flow chart illustrating aspects of a method for vehicle state verification, in accordance with an example embodiment.

FIG. 6 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to vehicle state verification.

Numerous technical inefficiencies exist in connection with implementing products and services that depend on projections concerning future behaviors or occurrences (e.g., insurance policies). For example, mileage is a significant indicator that can reflect the likelihood of an claim during the policy period of an auto insurance policy. But existing technologies do not efficiently and/or reliably enable the distance a driver is projected to travel over such a period to be appropriately weighted or accounted for when generating a policy. Aside from expensive, intrusive, and complex telematics solutions, such existing technologies cannot reliably capture, at regular intervals, how users actually drive. This results in numerous inefficiencies for both consumers and insurance providers.

Accordingly, described herein in various implementations are technologies that enable vehicle state verification and other related operations. Using the described technologies, various aspects of the state of a vehicle (e.g., the exterior and interior of a vehicle) can be reliably captured, e.g., at regular intervals (e.g., weekly or monthly ‘check-ins’). Such captured data can be processed (e.g., using image processing techniques) and verified/validated. In doing so, the described technologies can independently confirm that inputs that are otherwise self-reported by a user are likely to be authentic and thus a reliable indicator of the user's driving habits. By implementing the described technologies, both insurers and customers benefit by maintaining an independently verified activity history which can enable the implementation of insurance products and other services and applications that are better suited for the individual needs of the user. Additionally, the described technologies can be configured to incentivize a user's ongoing compliance with ongoing reporting requirements in a number of ways.

It can therefore be appreciated that the described technologies are directed to and address specific technical challenges and longstanding deficiencies in multiple technical areas, including but not limited to image processing, graphical user interfaces, and data verification and validation. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

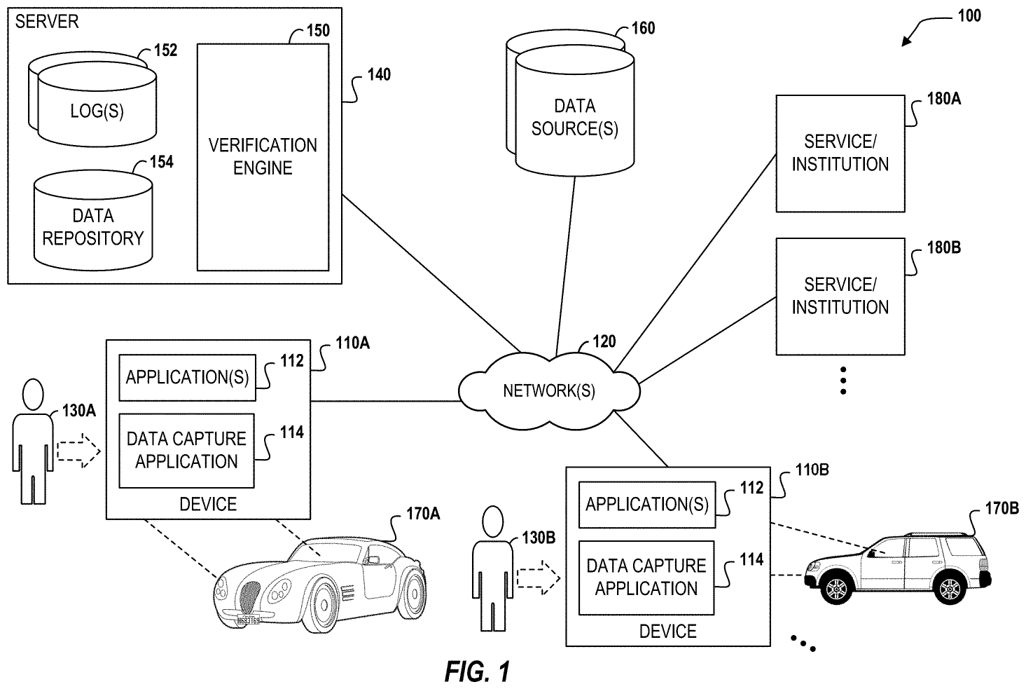

FIG. 1 illustrates an example system 100, in accordance with some implementations. As shown, the system 100 includes components such as devices 110A, 110B, etc. (collectively, “devices”). Each of the referenced devices 110 can be, for example, a smartphone, a mobile device, a tablet, a personal computer, a terminal, a smart watch, a wearable device, a digital music player, a connected device, a server, and the like.

Human users 130A, 130B, etc. can interact with respective device(s). For example, a user can provide various inputs (e.g., via an input device/interface such as a touchscreen, keyboard, mouse, microphone, etc.) to the referenced device(s). Such device(s) can also display, project, and/or otherwise provide content to users (e.g., via output components such as a screen, speaker, etc.).

As shown in FIG. 1, the referenced device(s) can include one or more application(s) 112, 114, etc. Such applications can be programs, modules, or other executable instructions that configure/enable the device to interact with, provide content to, and/or otherwise perform operations on behalf of a user.

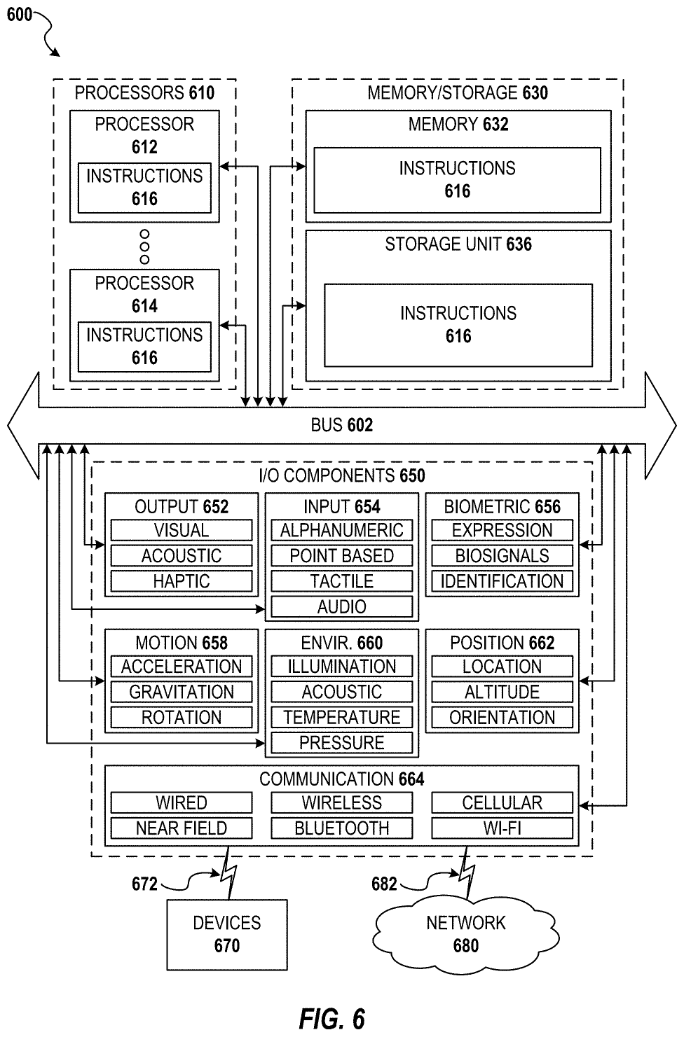

For example, application(s) 112 can include but are not limited to interne browsers, mobile apps, ecommerce applications, social media applications, personal assistant applications, games, etc. These and other application(s) can be stored in memory of a device 110 (e.g., memory 630 as depicted in FIG. 6 and described below). One or more processor(s) of the device (e.g., processors 610 as depicted in FIG. 6 and described below) can execute such application(s). In doing so, the device can be configured to perform various operations, present content to a user, etc., as described herein.

As also shown in FIG. 1, device(s) 110 can be configured to execute other application(s) such as data capture application 114. Data capture application 114 can be an application that executes on device 110 and enables the device to obtain, store, transmit, etc. various inputs and/or to perform various operations described herein. In certain implementations, data capture application 114 can interface or interact with various sensors of device 110, such as an integrated or connected camera, GPS, NFC or Bluetooth receiver, etc. Additionally, in certain implementations data capture application 114 can receive inputs provided by user 130 (e.g., via interactions with a touchscreen of the device, via voice inputs/commands, etc.).

By way of further illustration, in certain implementations application 114 can be configured to capture images and/or other information reflecting current state(s) of a vehicle (e.g., vehicle 170A, vehicle 170B, etc., as shown in FIG. 1). For example, application 114 can prompt the user to capture image(s) of the exterior and/or interior of a vehicle. Such image(s) can be further processed to extract information related to the vehicle (e.g., the vehicle's license plate), verify the license plate or other regulatory notation(s) associated with the vehicle, determine the current mileage of the vehicle, and/or compute/validate various state(s) of the vehicle (e.g., the condition of the vehicle), as described herein.

It should be noted that while the described application(s) 112, 114 are depicted and/or described as operating on a device (e.g., device 110), this is only for the sake of clarity. However, in other implementations such elements can also be implemented on other devices/machines. For example, in lieu of executing locally at device 110, aspects of such application(s) can be implemented remotely (e.g., on a server device or within a cloud service or framework).

As also shown in FIG. 1, device(s) 110 can connect to and/or otherwise communicate with other machines. For example, device(s) 110 can communicate with server 140 and/or various other servers, devices, services, etc., such as are described herein. Such communications can be transmitted and/or received via various network(s) 120 (e.g., cloud environments, the Internet, a wide area network (WAN), a local area network (LAN), a virtual private network (VPN), an intranet, and the like), communication protocols (e.g., Wifi, cellular, Bluetooth), etc. By way of further example, in certain implementations device(s) 110 can interface with a vehicle 170 (e.g., via OBD port, Bluetooth, and/or other communication interfaces). In doing so, device(s) 110 can request, receive, and/or otherwise obtain data from the vehicle reflecting the odometer reading of the vehicle and/or other status information, as described herein.

Server 140 can be, for example, a server computer, computing device, storage service (e.g., a ‘cloud’ service), etc. that verifies/validates data received from various sources, and otherwise manages aspects of the operation of data capture application 114 (e.g., as executing on device(s) 110). As described in detail herein, server 140 can process input(s) originating from device(s) 110 and/or application(s) 114. In doing so, the described technologies can, for example, verify or otherwise validate the state (e.g., mileage, condition, etc.) of a vehicle, and perform other related operations, as described herein.

In certain implementations, server 140 can include verification engine 150. Verification engine 150 can be an application, module, instructions, etc., that configures/enables the server to perform various operations described herein. For example, in certain implementations, verification engine 150 can process image(s) and/or other input(s) originating from application 114. In doing so, verification engine 150 can, for example, determine that images of a vehicle's odometer are consistent with the exterior of the vehicle (which can be determined to reflect, for example, the make and/or model of the vehicle). By way of further example, verification engine 150 can determine that a milage reading reflected in a current image (as received via application 114) is consistent with another image received with respect to the same vehicle (e.g., at prior chronological interval). In doing so, the described technologies can verify the current state of a vehicle, and initiate various operations based on such a state, as described herein.

As also shown in FIG. 1, server 140 can include various repositories including log repositorie(s) 152 and data repository 154. Such repositories can be storage resource(s) such as object-oriented databases, relational databases, decentralized or distributed ledgers (e.g., blockchain), etc. As described herein, verification engine 150 and/or other components can interact with such repositories to adjust the operation of data capture application 114, and/or perform other operations.

In certain implementations, logs 152 can maintain data structures or other records containing information that includes or reflect aspects of various instances or interactions, such as ‘check in’ instances occurring with respect to one or more vehicle(s) 170 and/or user(s) 130. As described herein, at each such ‘check in’ instance (which can occur, for example, weekly), log 152 can maintain records reflecting data collected in connection with the user's use of application 114. Such data can include, for example, captured image(s) and/or other input(s) associated with vehicle 170. As noted, such inputs can be processed to determine, for example, the current mileage of the vehicle. Additionally, in certain implementations such inputs can include or otherwise reflect a geographic location of the vehicle and/or the user. It should be understood that the described inputs, logs, determinations, etc. are provided by way of example, and any number of other information, data, determinations, can also be computed and/or stored.

Moreover, in certain implementations the described technologies can enable user(s) 130 to ‘opt-in,’ ‘opt-out,’ and/or otherwise configure various security parameters, settings, etc. For example, the user can be able to configure what types of content should or should not be stored. Additionally, in certain implementations various techniques which derive insights from collected data (while deleting the underlying data after a specified interval) and/or anonymization techniques can be employed. Moreover, in certain implementations the referenced repositories and other components can utilize various types of data encryption, identity verification, and/or related technologies to ensure that the content cannot be accessed or retrieved by unauthorized parties. Doing so can ensure that the described technologies enable realization of the described benefits and technical improvements while maintaining the security and privacy of the user's data.

Data repository 154 can maintain data structures or other records containing rules, conditions, and/or other instructions reflecting the manner in which inputs (such as those originating from device(s) 110) are to be processed. Such rules, conditions, etc., can reflect, for example, aspects of prior determinations (e.g., visual patterns, characteristics, aspects, etc., of an interior of a particular vehicle model that correspond to aspects of a vehicle exterior), as described herein.

As also shown in FIG. 1, server 140 can be configured to communicate with and/or access various external data source(s) 160. Such data sources 160 can be, for example, third-party services capable of providing information regarding vehicle(s) 170, user(s) 130, device(s) 110, and/or other information. For example, one such data source can provide diagrams or other technical specifications or information relating to or otherwise reflecting the exterior and/or interior properties of various vehicles. By way of illustration, one such data source can correspond to a database maintained by one car manufacturer, containing diagrams, specifications, etc., reflecting the dimensions, layout, etc., of its cars (e.g., car 170A), while another manufacturer can maintain its own database with comparable information relating to its own cars (e.g., car 170B). Such information can be requested, received, and/or used (e.g., by verification engine 150) to process images(s) provided by the referenced device(s) 110. In doing so, the described technologies can, for example, determine a vehicle model of a vehicle depicted in an image provided by application 114, and further determine whether an odometer, instrument panel, etc. depicted in an associated photograph is consistent with such a vehicle model, as described herein.

In certain implementations, device(s) 110 and/or server 140 can be configured to communicate or otherwise interface with various services, institutions, payment networks, etc., such as third-party service(s)/institution(s) 180. Examples of such services or institutions include but are not limited to insurance providers, ecommerce sites, payment services, websites, platforms, etc. In other implementations, the referenced services can also include various decentralized or distributed platforms or networks. Such platforms can include or otherwise interface with a decentralized or distributed ledger such as a blockchain (e.g., Bitcoin, Ethereum, etc.) that can be distributed/stored across multiple connected nodes. In certain implementations, such distributed platforms can enable transferring ownership of digital tokens or cryptocurrencies, e.g., via public/private keys or and/or other cryptographic techniques.

For example, in certain implementations, service(s)/institution(s) 180 can include insurance providers with which user(s) 130 can obtain vehicle insurance. For example, user 130A can maintain auto insurance via insurance provider 180A. Using data capture application 114 (as executing on device 110A) user 130A can provide input(s) that can be processed by the described technologies to verify (e.g., on a routine basis) aspects of the manner in which the user utilizes the insured vehicle, as described herein. The described technologies can further perform other operations based on such determination(s), as described herein.

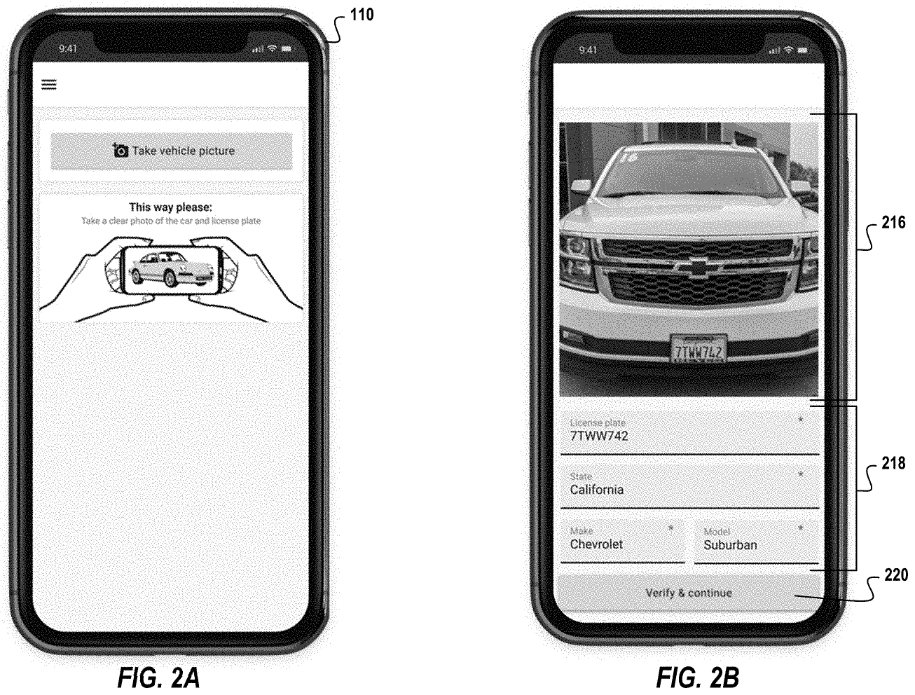

FIG. 2A depicts an example graphical user interface (“GUI”) of application 114, e.g., as executing on device 110A and as presented to user 130A. As described herein, a user can interact with interface(s) of application 114, and the described technologies can capture various input(s) (and other data), process such inputs to determine state(s) of a vehicle, and further validate aspects of the use/operation of the vehicle, as described herein. As shown in FIG. 2A, application 114, can prompt the user to take one or more pictures of a vehicle, e.g., from specified directions, angles, etc. Such an interface can include selectable control(s) and visual instruction(s), as shown.

By interacting with the referenced GUI, user 130 can capture image(s) of the referenced vehicle (e.g., the exterior of the vehicle, such as the front, back, and/or sides of the vehicle). Such captured image(s) can be processed, e.g., using various image processing techniques, as described herein. In doing so, the described technologies can verify or validate the current state of a vehicle, as described herein.

The described technologies can process the referenced image(s) in various ways. For example, in certain implementations aspects of the images of the exterior of the vehicle can be processed to determine that a vehicle can be identified within such image(s). In a scenario in which a vehicle is unlikely to be identified, the described technologies can, for example, prompt the user to retake one or more such photos.

By way of further example, in certain implementations the described technologies can utilize optical character recognition and/or other image processing techniques to identify the license plate number (and the issuing state) associated with the vehicle. By way of further example, in certain implementations the described technologies can utilize optical character recognition techniques to identify aspects of the make and/or model of the vehicle. By way of yet further example, in certain implementations the described technologies can utilize other image processing techniques (e.g., machine learning techniques) to determine the make and/or model of the vehicle.

It should be understood that the described image processing, etc. techniques are provided by way of example, and any number of other technologies can also be utilized to process the referenced inputs. Additionally, as also described herein, in certain implementations aspects of the referenced processing operation(s) can be performed at device 110 while in other implementations aspects of the referenced operation(s) can be performed at server 140 and/or at one or more other machines.

FIG. 2B depicts an example GUI of application 114, e.g., after various input(s) (such as a photograph of vehicle 170) are processed. As shown in FIG. 2B, application 114 can present the user with captured image(s) 216 of the referenced vehicle, together with information 218 extracted from such image(s). For example, the referenced GUI can present extracted license plate information (e.g., plate number, state, etc.), and the make/model of the vehicle, as shown. Application 114 can further enable the user to review and modify or adjust any such extracted information (e.g., to correct errors in the character recognition or vehicle recognition operations). The user can further verify the extracted information via a selectable control, button, etc., 220 within the GUI, as shown.

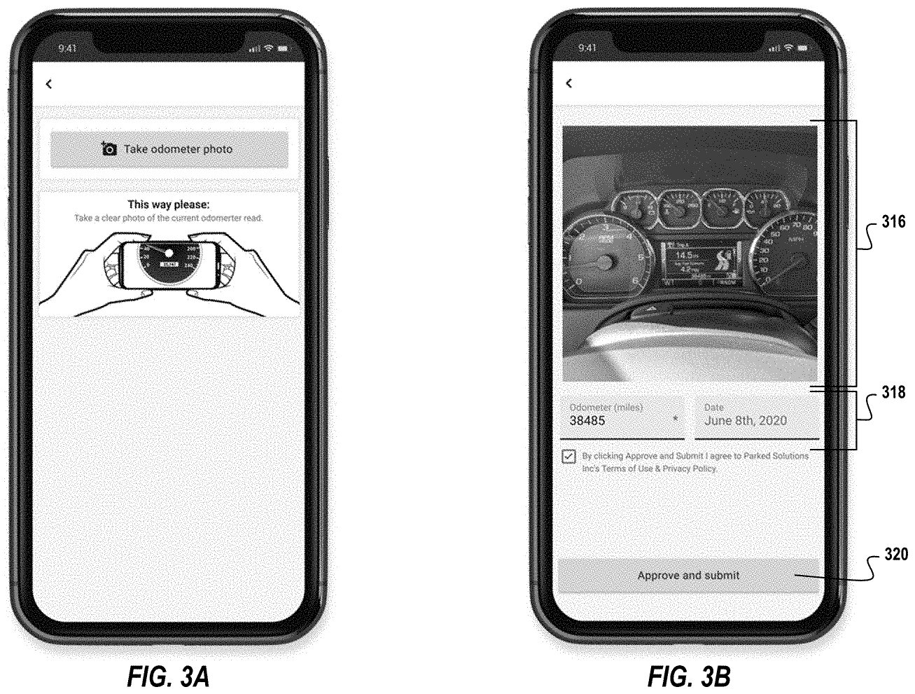

FIG. 3A depicts an example GUI of application 114, e.g., as executing on device 110A and as presented to user 130A. As shown in FIG. 3A, application 114 can prompt the user to capture image(s) of the interior of the referenced vehicle 170. For example, in certain implementations application 114 can prompt the user to capture images of the odometer of the vehicle.

As shown in FIG. 3B, application 114 can capture image(s) 316 of the interior of vehicle 170, including those depicting the odometer of the vehicle (and/or other such gauges, controls, etc.). Such image(s) can be processed (e.g., using image processing techniques including OCR) to extract reading(s) reflected by such gauges (e.g., the current mileage as shown by the vehicle's odometer). As noted, in certain implementations aspects of such processing operation(s) can be performed at device 110 and/or at server 140 or other machine(s). The referenced odometer reading can be presented to the user via application 114, e.g., to enable the user to review and/or modify such extracted information (e.g., to correct errors in the character recognition or vehicle recognition operations). The user can further verify the extracted information 318 via a selectable control, button, etc., 320 within the GUI, as shown.

As noted, the described technologies can process the referenced image(s) in various ways. For example, in certain implementations aspects of the images of the interior of the vehicle can be processed to determined that an odometer and/or various other vehicle gauges, controls, etc. can be identified within such image(s). In a scenario in which an odometer is unlikely to be identified, the described technologies can, for example, prompt the user to retake one or more such photos.

The described technologies can further process the referenced inputs in various ways, including in relation to one another. For example, in certain implementations aspects of the images of the exterior of the vehicle (e.g., as captured in the manner described with respect to FIGS. 2A-2B) can be compared with aspects of the images of the interior of the vehicle (e.g., as captured in the manner described with respect to FIGS. 3A-3B). Doing so can further verify the current state of the vehicle, as described herein.

By way of illustration, metadata (e.g., in EXIF format as stored within the referenced images), such as parameters reflecting the time, date, location, etc., at which various images were captured can be compared. In doing so, images (such as both vehicle exterior and vehicle interior images) captured within a defined chronological interval (e.g., within 30 minutes) of one another can be determined to be likely to be authentic (and thus suitable for verifying a current state of the vehicle). By way of further illustration, location parameters (e.g., GPS coordinates) of such respective image(s) can be compared, and those determined to have been captured within a defined distance of one another (e.g., 30 meters) can be determined to be likely to be authentic (and thus suitable for verifying a current state of the vehicle). In contrast, images captured outside such a defined chronological interval (e.g., more than 30 minutes apart) and/or outside such a defined distance (e.g., more than 30 meters apart) can be determined to be insufficient to verify a current state of the vehicle. In such a scenario, the described technologies can, for example, prompt the user to retake one or more such photos. By way of yet further example, the described technologies can process metadata associated with the received images (e.g., metadata reflecting a device type and/or unique device identifier) to determine that the images (e.g., those corresponding to the exterior/license plate of a vehicle and those corresponding to the interior/odometer reading) were captured by the same device.

Additionally, in certain implementations the described technologies can verify aspects of the captured image(s) in relation to external data sources. For example, metadata reflecting the time, date, location, etc., at which various images were captured can be compared with the current time, date, etc. maintained at a device (e.g., device 110, server 140, etc.). In doing so, images associated with metadata reflecting that such images were recently captured (e.g., within the past 30 minutes) can be determined to be likely to be authentic (and thus suitable for verifying a current state of the vehicle). In contrast, images captured outside such a chronological interval can be determined to be more likely to be inauthentic (as they may not reflect the current state of the vehicle). In such a scenario, the described technologies can, for example, prompt the user to retake one or more such photos.

As noted, aspects of the information extracted from images of the interior of the vehicle can be processed to verify or validate the vehicle's current state. For example, in certain implementations the described technologies can compare extracted odometer reading information with corresponding odometer reading(s) from prior ‘check ins’ (e.g., as stored in logs 152). In doing so, the described technologies can confirm that the current odometer reading is greater than prior reading(s). In a scenario in which a current reading is less than prior reading(s), the described technologies can, for example, prompt the user to retake one or more such photos.

By way of further illustration, in certain implementations the described technologies can further process aspects of the information extracted from images corresponding to the exterior of a vehicle in relation to information extracted from images corresponding to the interior of the vehicle. For example, the described technologies can generate or otherwise identify association(s) between visual patterns reflected in an interior of a vehicle (e.g., odometer style, dashboard layout, etc.) and the exterior of a vehicle (reflecting the vehicle make and model). Such associations can be determined, for example, based on designs, diagrams, manuals, or other information originating from external sources. Moreover, in certain implementations such associations (e.g., between the layout of a dashboard and a vehicle make/model) can be identified based on the processing of multiple such vehicles, using various machine learning techniques. As noted, such information (including the underlying associations between interior and exterior vehicle characteristics) can be stored in repository 154. Accordingly, upon determining, for example, that the current vehicle is of the same/comparable make/model, the described technologies can further determine whether the interior characteristics of the image(s) provided via application 114 conform to the patterns, etc., reflected in the interior images of previously observed vehicles.

Additionally, the described technologies can utilize such associations (e.g., between exterior and interior vehicle characteristics) to further enhance aspects of the processing of the referenced image(s). For example, upon identifying the make/model of a vehicle (e.g., based on images of the exterior of the vehicle, as described herein), image(s) of the interior of the vehicle can be processed in a manner that attempts to verify or determine that visual characteristics reflected within the provided interior image(s) are consistent with the instrument panel, layout, etc. associated with such a make/model. By way of further example, the described technologies can utilize characteristics of the instrument panel, layout, etc. associated with such a make/model to process image(s) of the interior of the vehicle in a manner that attempts to identify an odometer reading and/or other alphanumeric characters within certain region(s) of such interior image(s).

Moreover, in certain implementations the described technologies can compare image(s) currently captured (e.g., by application 114) with those previously captured (e.g., at previous ‘check ins,’ such as are stored in log(s) 152). For example, currently provided images of an exterior of a vehicle can be compared to those captured at prior instances to identify potential discrepancies between them. Such discrepancies include, for example, whether the vehicle is the same color, in the same condition, has the same identifying features (e.g., bumper stickers, bike rack, etc.). Identification of various discrepancies can reflect that the current image(s) may not reflect the current state of the vehicle. Additionally, in certain implementations the described technologies can process captured image(s) to confirm such images are unique, e.g., with respect to one another and/or to previously received/stored images. In doing so, the described technologies can identify instances in which the same image is provided at multiple ‘check ins’ (reflecting that the image is not an accurate reflection of the current state of the vehicle).

By way of further illustration, currently provided images of an interior of a vehicle can be compared to those captured at prior instances to identify potential discrepancies. Such discrepancies include, for example, whether the dashboard layout remains the same, whether the interior layout has the same identifying features (e.g., gauge style/color, etc.). Identification of various discrepancies can reflect that the current image(s) may not reflect the current state of the vehicle.

By way of further example, the described technologies can process received image(s) to identify characteristics, attributes, etc. reflecting that such image(s) originate from other sources (and were not captured directly from the vehicle itself). For example, the described technologies can process received images to identify characteristics reflecting that such image(s) are screenshots (e.g., by identifying the presence of a navigation/status bar and/or other characteristics of a device's user interface). By way of further example, such images can be processed to identify ‘banding’ or other visual characteristics reflecting that such image(s) were likely captured by photographing a screen (as opposed to the vehicle itself). By way of yet further example, the referenced image(s) can be processed to determine they are actual photos (and were not, for example, generating using artificial intelligence tools or techniques capable of generating images).

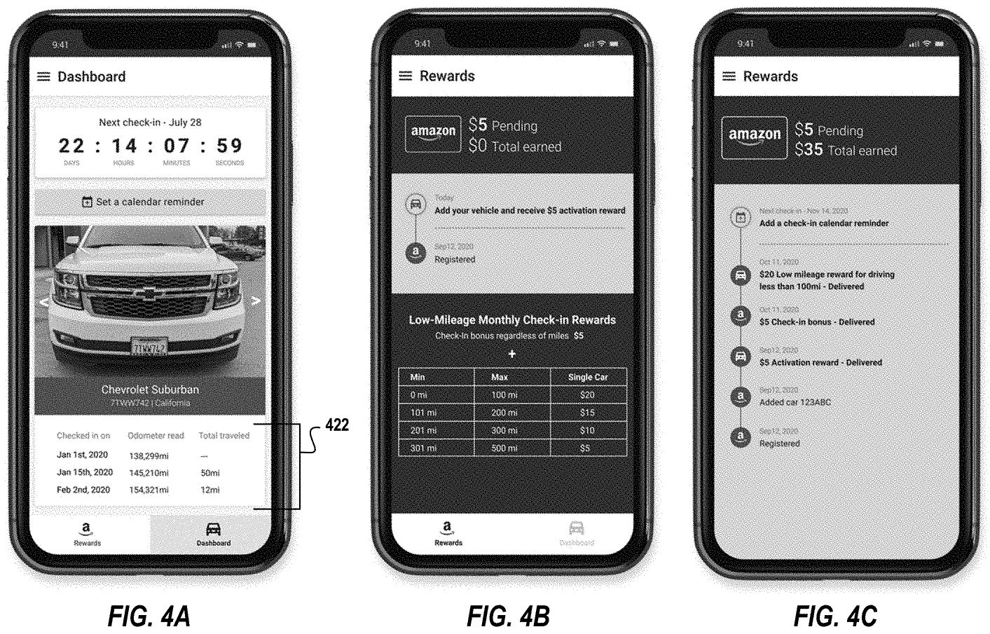

As noted, the described technologies can enable users, insurance companies, and other entities to receive updates, at regular intervals, the manner in which a vehicle is being used. For example, FIG. 4A depicts a GUI which includes a history 422 of a user's ‘check ins,’ including the date of such check ins and the corresponding odometer reading on each date. As noted, in certain implementations the user can retain control over such information (such that it can, for example, be utilized in future operations, e.g., with respect to other services, insurance providers, etc.).

The described technologies can also be configured to facilitate the provision of various promotions, rewards, etc., to users. For example, as shown in FIGS. 4B-4C, the described technologies can incentivize compliance with regular ‘check ins’ by providing rewards (e.g., ecommerce gift cards, bill credits, cash, etc.). Additionally, in certain implementations the described technologies can further incentivize users towards or away from certain behaviors (e.g., to drive less) by implementing promotions, rewards, etc., based on low mileage readings. It should be understood that the implementation of such rewards, promotions, etc. are provided by way of example, and any number of other frameworks can also be utilized to incentivize compliance.

Moreover, in certain implementations, various aspects of the described technologies can be adjusted and/or configured based on inputs or determinations originating from various sensors and/or other devices. For example, in certain implementations, inputs originating from a GPS receiver of one or more devices associated with a user can be utilized or accounted for in adjusting aspects of the configuration and/or operation of data capture application 114. For example, based on determination(s) that a user is visiting another state or country, the described technologies can adjust or configure aspects of the described technologies (e.g., to prompt the user to verify aspects of their driving at different intervals).

In these and other implementations and scenarios, the described technologies can further configure and/or otherwise interact with various sensor(s) to enhance and/or improve the functioning of one or more machine(s). Doing so can enhance the security, execution, and operation of the described technologies, as described herein. In contrast, existing technologies are incapable of enabling performance of the described operations in a manner that ensures their efficient execution and management, while also maintaining the security and integrity of such operations, as described herein.

While many of the examples described herein are illustrated with respect to multiple machines 110, 140, 160, 180, etc., this is simply for the sake of clarity and brevity. However, it should be understood that the described technologies can also be implemented (in any number of configurations) with respect to a single computing device/service.

Additionally, in certain implementations various aspects of the operations that are described herein with respect to a single machine (e.g., server 140) can be implemented with respect to multiple machines. For example, in certain implementations data repository 154 can be implemented as an independent server, machine, service, etc.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

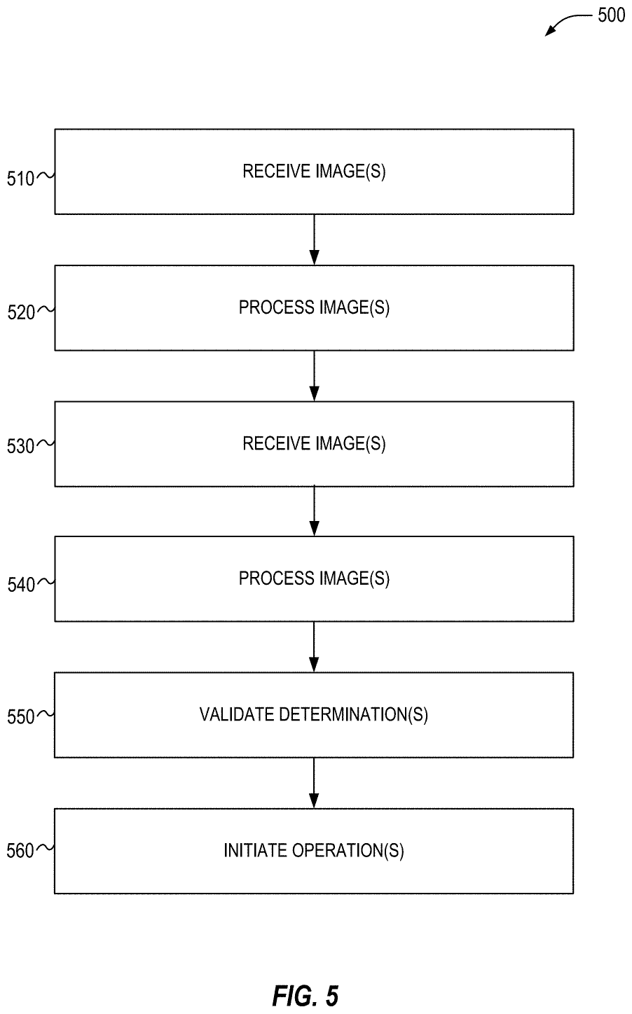

In certain implementations, various aspects of the described technologies include methods performed by processing logic that can comprise hardware (circuitry, dedicated logic, etc.), software (such as is run on a computing device such as those described herein), or a combination of both. For example, FIG. 5 is a flow chart illustrating a method 500, according to an example embodiment, for vehicle state verification. The method is performed by processing logic that can comprise hardware (circuitry, dedicated logic, etc.), software (such as is run on a computing device such as those described herein), or a combination of both. In one implementation, the method 500 is performed by one or more elements depicted and/or described in relation to FIG. 1 (including but not limited to server 140, verification engine 150, and/or device(s) 110), while in some other implementations, one or more blocks of FIG. 5 (and/or other described operations) can be performed by another machine or machines.

For simplicity of explanation, methods are described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the disclosed methods are capable of being stored on an article of manufacture to facilitate transporting and transferring such methods to computing devices. The term article of manufacture, as used herein, is intended to encompass a computer program accessible from any computer-readable device or storage media.

At operation 510, one or more first images (and/or other content or information) are received. In certain implementations, such image(s) can be received at server 140 and/or verification engine 150. As described herein, in certain implementations such image(s) can reflect various aspects of the state of a vehicle (e.g., the exterior of the vehicle). By way of illustration, in certain implementations such image(s) can be captured in the manner depicted in FIGS. 2A-2B and described herein.

At operation 520, the one or more first images (e.g., those received at 510) are processed. In doing so, one or more aspects, characteristics, etc. of a vehicle (e.g., aspects of the exterior of the vehicle) can be determined or otherwise extracted.

For example, the received images can be processed to identify a license plate, the make/model of the vehicle, and/or a condition of the vehicle, within the one or more first images. As described herein, in certain implementations the described technologies can utilize optical character recognition and/or other image processing techniques to identify the license plate number (and the issuing state) associated with the vehicle depicted in the received image(s). By way of further example, in certain implementations the described technologies can utilize optical character recognition and/or machine learning techniques to identify aspects of the make and/or model of the vehicle.

As described herein, in certain implementations such determinations can be computed based on comparison(s) of the received image(s) and previously received image(s) (e.g., as stored in repository 154) and/or information from external sources 160.

Additionally, in certain implementations the referenced images can be processed to determine their origin and/or authenticity, e.g., as described herein. For example, in certain implementations the referenced images can be processed to determine they are actual photos (and were not, for example, edited, modified, and/or generated using artificial intelligence tools or techniques capable of generating images).

At operation 530, one or more second images (and/or other content or information) are be received (e.g., at server 140 and/or verification engine 150). As described herein, in certain implementations such image(s) can reflect various aspects of the state of a vehicle (e.g., the interior of the vehicle). By way of illustration, in certain implementations such image(s) can be captured in the manner depicted in FIGS. 3A-3B and described herein.

At operation 540, the one or more second images (e.g., those received at 530) are processed. In doing so, one or more aspects, characteristics, etc. of a vehicle (e.g., aspects of the interior of the vehicle) can be determined or otherwise extracted.

For example, in certain implementations the received images can be processed to identify an instrument panel and/or odometer within the one or more second images. As described herein, in certain implementations such determinations can be computed based on comparison(s) of the received image(s) and previously received image(s) (e.g., as stored in repository 154) and/or information from external sources 160. By way of illustration, images(s) of an interior of a vehicle can be processed with respect to images, diagrams, etc., maintained by an external source (and corresponding to a particular vehicle make/model) to determine whether an odometer, instrument panel, etc. depicted in the received image is consistent with such a vehicle make/model, as described herein.

Additionally, in certain implementations the referenced images can be processed to determine their origin and/or authenticity. For example, the described technologies can process received image(s) to identify characteristics, attributes, etc. reflecting that such image(s) originate from other sources (and were not captured directly from the vehicle itself). For example, the described technologies can process received images to identify characteristics reflecting that such image(s) are screenshots (e.g., by identifying the presence of a navigation/status bar and/or other characteristics of a device's user interface). By way of further example, such images can be processed to identify ‘banding’ or other visual characteristics reflecting that such image(s) were likely captured by photographing a screen (as opposed to the vehicle itself). By way of yet further example, the referenced image(s) can be processed to determine they are actual photos (and were not, for example, generating using artificial intelligence tools or techniques capable of generating images).

At operation 550, determinations computed with respect to the received images (e.g., at 520 and 540) can be validated (e.g., by server 140 and/or verification engine 150). In doing so, determined aspect(s) of the interior of the vehicle can, for example, be validated respect to the determined aspect(s) of the exterior of a vehicle.

For example, an odometer identified within one set of images can be validated to correspond to a make/model of a vehicle identified within an associated set of images (e.g., those determined to have been captured and/or received within chronological and/or geographic proximity to one another). As described herein, associations between sets of images can be determined based on metadata embedded within such images (which can reflect, for example, that both sets of images were captured by the same device and/or device type, within a defined chronological interval of one another, and/or within defined geographic proximity to one another).

By way of further illustration, metadata (such as parameters reflecting the time, date, location, etc., at which various images were captured) can be compared. In doing so, images (such as both vehicle exterior and vehicle interior images) captured within a defined chronological interval (e.g., within 30 minutes) of one another can be determined to be likely to be authentic (and thus suitable for verifying a current state of the vehicle).

By way of further illustration, location parameters (e.g., GPS coordinates) of such respective image(s) can be compared, and those determined to have been captured within a defined distance of one another (e.g., 30 meters) can be determined to be likely to be authentic (and thus suitable for verifying a current state of the vehicle). In contrast, images captured outside such a defined chronological interval (e.g., more than 30 minutes apart) and/or outside such a defined distance (e.g., more than 30 meters apart) can be determined to be insufficient to verify a current state of the vehicle.

By way of yet further example, the described technologies can process metadata associated with the received images (e.g., metadata reflecting a device type and/or unique device identifier) to determine that the images (e.g., those received at 510, which can correspond to the exterior/license plate of a vehicle and those received at 530 which can correspond to the interior/odometer reading) were captured by the same device.

Additionally, in certain implementations the described technologies can validate and/or verify aspects of the captured image(s) in relation to external data sources. For example, metadata reflecting the time, date, location, etc., at which various images were captured can be compared with the current time, date, etc. maintained at a device (e.g., device 110, server 140, etc.). In doing so, images associated with metadata reflecting that such images were recently captured (e.g., within the past 30 minutes) can be determined to be likely to be authentic (and thus suitable for verifying a current state of the vehicle). In contrast, images captured outside such a chronological interval can be determined to be more likely to be inauthentic (as they may not reflect the current state of the vehicle).

As noted, aspects of the information extracted from images of the interior of the vehicle can be processed to verify or validate the vehicle's current state. For example, in certain implementations the described technologies can compare extracted odometer reading information with corresponding odometer reading(s) from prior ‘check ins’ (e.g., as stored in logs 152). In doing so, the described technologies can confirm that the current odometer reading is greater than prior reading(s). In a scenario in which a current reading is less than prior reading(s), the described technologies can, for example, prompt the user to retake one or more such photos.

By way of further illustration, in certain implementations the described technologies can further process aspects of the information extracted from images corresponding to the exterior of a vehicle (e.g., those received at 510) in relation to information extracted from images corresponding to the interior of the vehicle (e.g., those received at 530). For example, the described technologies can generate or otherwise identify association(s) between visual patterns reflected in an interior of a vehicle (e.g., odometer style, dashboard layout, etc.) and the exterior of a vehicle (reflecting the vehicle make and model). Such associations can be determined, for example, based on designs, diagrams, manuals, or other information originating from external sources. Moreover, in certain implementations such associations (e.g., between the layout of a dashboard and a vehicle make/model) can be identified based on the processing of multiple such vehicles, using various machine learning techniques. As noted, such information (including the underlying associations between interior and exterior vehicle characteristics) can be stored in repository 154. Accordingly, upon determining (e.g., at 520) that the current vehicle is of the same/comparable make/model, the described technologies can further determine whether the interior characteristics of image(s) of the interior of the vehicle (e.g., as received at 530) conform to the patterns, etc., reflected in the interior images of previously observed vehicles.

Additionally, the described technologies can utilize such associations (e.g., between exterior and interior vehicle characteristics) to further enhance aspects of the processing of the referenced image(s). For example, upon identifying the make/model of a vehicle (e.g., based on images of the exterior of the vehicle, as described herein), image(s) of the interior of the vehicle can be processed in a manner that attempts to verify or determine that visual characteristics reflected within the provided interior image(s) are consistent with the instrument panel, layout, etc. associated with such a make/model. By way of further example, the described technologies can utilize characteristics of the instrument panel, layout, etc. associated with such a make/model to process image(s) of the interior of the vehicle in a manner that attempts to identify an odometer reading and/or other alphanumeric characters within certain region(s) of such interior image(s).

Moreover, in certain implementations the described technologies can compare image(s) currently received (e.g., at 510 and/or 530) with those previously received (e.g., at previous ‘check ins,’ such as are stored in log(s) 152). For example, images of an exterior of a vehicle (e.g., as received at 510) can be compared to those received at prior instances to identify potential discrepancies between them. Such discrepancies include, for example, whether the vehicle is the same color, in the same condition, has the same identifying features (e.g., bumper stickers, bike rack, etc.). Identification of various discrepancies can reflect that the current image(s) may not reflect the current state of the vehicle. Additionally, in certain implementations the described technologies can process currently received image(s) to confirm such images are unique, e.g., with respect to one another and/or to previously received/stored images. In doing so, the described technologies can identify instances in which the same image is provided at multiple ‘check ins’ (reflecting that the image is not an accurate reflection of the current state of the vehicle).

By way of further illustration, images of an interior of a vehicle (e.g., as received at 530) can be compared to those received at prior instances to identify potential discrepancies. Such discrepancies include, for example, whether the dashboard layout remains the same, whether the interior layout has the same identifying features (e.g., gauge style/color, etc.). Identification of various discrepancies can reflect that the currently received image(s) may not reflect the current state of the vehicle.

By way of further example, the described technologies can process received image(s) to identify characteristics, attributes, etc. reflecting that such image(s) originate from other sources (and were not captured directly from the vehicle itself). For example, the described technologies can process received images to identify characteristics reflecting that such image(s) are screenshots (e.g., by identifying the presence of a navigation/status bar and/or other characteristics of a device's user interface). By way of further example, such images can be processed to identify ‘banding’ or other visual characteristics reflecting that such image(s) were likely captured by photographing a screen (as opposed to the vehicle itself). By way of yet further example, the referenced image(s) can be processed to determine they are actual photos (and were not, for example, generating using artificial intelligence tools or techniques capable of generating images).

At operation 560, operation(s) can be initiated. In certain implementations, such operation(s) can be initiated based on the validation (e.g., at 550). For example, in certain implementations validated records (reflecting the state of the vehicle) can be generated and/or associated with one another, as described herein.

It should be understood that the examples provided herein are intended only for purposes of illustration and any number of other implementations are also contemplated. Additionally, the referenced examples and implementations can be combined in any number of ways. For example, in certain implementations the described technologies can be configured with respect to homeowners' insurance policies (e.g., by prompting users to provide images of the insured home or property at regular intervals and processing such images to validate the information provided). Additionally, the referenced examples can be combined in any number of ways. In doing so, the described technologies can enhance and/or improve the functioning of one or more machine(s) and/or increase the security of various transactions, as described herein.

It can be appreciated that the described technologies provide numerous technical advantages and improvements over existing technologies. For example, the described technologies can enable the automated verification and validation of the state and mileage of a vehicle while also providing enhanced functionality and efficiency, as described herein. These and other described features, as implemented with respect to machines 110, 140, 160, 180 and/or one or more particular machine(s), can improve the functioning of such machine(s) and/or otherwise enhance numerous technologies including enabling and enhancing the security, execution, and management of various transactions, as described herein.

It should also be noted that while the technologies described herein are illustrated primarily with respect to vehicle state and/or mileage verification, these technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-4C are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 6 is a block diagram illustrating components of a machine 600, according to some example implementations, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein can be executed. The instructions 616 transform the non-programmed machine into a particular machine programmed to carry out the described and illustrated functions in the manner described. In alternative implementations, the machine 600 operates as a standalone device or can be coupled (e.g., networked) to other machines. In a networked deployment, the machine 600 can operate in the capacity of a server machine or a client machine in a server-client network environment, or as a peer machine in a peer-to-peer (or distributed) network environment. The machine 600 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 can include processors 610, memory/storage 630, and I/O components 650, which can be configured to communicate with each other such as via a bus 602. In an example implementation, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 612 and a processor 614 that can execute the instructions 616. The term “processor” is intended to include multi-core processors that can comprise two or more independent processors (sometimes referred to as “cores”) that can execute instructions contemporaneously. Although FIG. 6 shows multiple processors 610, the machine 600 can include a single processor with a single core, a single processor with multiple cores (e.g., a multi-core processor), multiple processors with a single core, multiple processors with multiples cores, or any combination thereof.

The memory/storage 630 can include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 can also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of the processors 610 are examples of machine-readable media.

As used herein, “machine-readable medium” means a device able to store instructions (e.g., instructions 616) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine (e.g., processors 610), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 650 can include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 can include many other components that are not shown in FIG. 6. The I/O components 650 are grouped according to functionality merely for simplifying the following discussion and the grouping is in no way limiting. In various example implementations, the I/O components 650 can include output components 652 and input components 654. The output components 652 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 650 can include biometric components 656, motion components 658, environmental components 660, or position components 662, among a wide array of other components. For example, the biometric components 656 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 can include acceleration sensor components (e.g., accelerometer), gravitation sensor components, rotation sensor components (e.g., gyroscope), and so forth. The environmental components 660 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 662 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 650 can include communication components 664 operable to couple the machine 600 to a network 680 or devices 670 via a coupling 682 and a coupling 672, respectively. For example, the communication components 664 can include a network interface component or other suitable device to interface with the network 680. In further examples, the communication components 664 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 can be another machine or any of a wide variety of peripheral devices (e.g., a peripheral device coupled via a USB).

Moreover, the communication components 664 can detect identifiers or include components operable to detect identifiers. For example, the communication components 664 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 664, such as location via Internet Protocol (IP) geolocation, location via Wi-Fi® signal triangulation, location via detecting an NFC beacon signal that can indicate a particular location, and so forth.

In various example implementations, one or more portions of the network 680 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 can include a wireless or cellular network and the coupling 682 can be a Code Division Multiple Access (CDMA) connection, a Global System for Mobile communications (GSM) connection, or another type of cellular or wireless coupling. In this example, the coupling 682 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 6G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 can be transmitted or received over the network 680 using a transmission medium via a network interface device (e.g., a network interface component included in the communication components 664) and utilizing any one of a number of well-known transfer protocols (e.g., HTTP). Similarly, the instructions 616 can be transmitted or received using a transmission medium via the coupling 672 (e.g., a peer-to-peer coupling) to the devices 670. The term “transmission medium” shall be taken to include any intangible medium that is capable of storing, encoding, or carrying the instructions 616 for execution by the machine 600, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
receiving one or more first images;
processing the one or more first images to determine one or more aspects of an exterior of a vehicle;
receiving one or more second images;
processing the one or more second images to determine one or more aspects of an interior of the vehicle;
validating the determined one or more aspects of the interior of the vehicle with respect to the determined one or more aspects of the exterior of a vehicle; and
initiating one or more operations based on the validation.

2. The system of claim 1, wherein processing the one or more first images comprises identifying a license plate within the one or more first images.

3. The system of claim 1, wherein processing the one or more first images comprises identifying at least one of a make of the vehicle or a model of the vehicle.

4. The system of claim 1, wherein processing the one or more first images comprises determining a condition of the vehicle.

5. The system of claim 1, wherein processing the one or more first images comprises processing the one or more first images with one or more images previously received with respect to the vehicle.

6. The system of claim 1, wherein processing the one or more first images comprises processing the one or more first images to determine an origin of the one or more first images.

7. The system of claim 1, wherein processing the one or more second images comprises identifying an odometer within the one or more second images.

8. The system of claim 1, wherein processing the one or more second images comprises processing the one or more second images with one or more images previously received with respect to the vehicle.

9. The system of claim 1, wherein processing the one or more second images comprises processing the one or more second images to determine an origin of the one or more first images.

10. The system of claim 1, wherein validating the determined one or more aspects of the interior of the vehicle with respect to the determined one or more aspects of the exterior of a vehicle comprises determining that an odometer identified within the one or more second images is consistent with at least one of a make of the vehicle or a model of the vehicle identified with respect to the one or more first images.

11. The system of claim 1, wherein validating the determined one or more aspects of the interior of the vehicle with respect to the determined one or more aspects of the exterior of a vehicle comprises comparing metadata associated with the one or more first images with metadata associated with the one or more second images.

12. The system of claim 1, wherein validating the determined one or more aspects of the interior of the vehicle with respect to the determined one or more aspects of the exterior of a vehicle comprises comparing a chronological interval associated with a capture of the one or more first images with a chronological interval associated with a capture of the one or more second images.

13. The system of claim 1, wherein validating the determined one or more aspects of the interior of the vehicle with respect to the determined one or more aspects of the exterior of a vehicle comprises comparing one or more geographic coordinates associated with the one or more first images with one or more geographic coordinates associated with the one or more second images.

14. The system of claim 1, wherein validating the determined one or more aspects of the interior of the vehicle with respect to the determined one or more aspects of the exterior of a vehicle further comprises validating, in relation to inputs originating from one or more sensors of the vehicle, the determined one or more aspects of the interior of the vehicle with respect to the determined one or more aspects of the exterior of a vehicle.

15. The system of claim 1, wherein initiating one or more operations comprises generating a record based on the validation.

16. The system of claim 1, wherein initiating one or more operations comprises associating a validated record with one or more previously generated records.

17. A method comprising::
receiving one or more first images;
processing the one or more first images to determine one or more aspects of an exterior of a vehicle;
receiving one or more second images;
processing the one or more second images with one or more images previously received with respect to the vehicle to determine one or more aspects of an interior of the vehicle;
validating the determined one or more aspects of the interior of the vehicle with respect to the determined one or more aspects of the exterior of a vehicle; and
initiating one or more operations based on the validation.

18. The method of claim 17, wherein validating the determined one or more aspects of the interior of the vehicle with respect to the determined one or more aspects of the exterior of a vehicle comprises determining that an odometer identified within the one or more second images is consistent with at least one of a make of the vehicle or a model of the vehicle identified with respect to the one or more first images.

19. The method of claim 17, wherein validating the determined one or more aspects of the interior of the vehicle with respect to the determined one or more aspects of the exterior of a vehicle comprises comparing metadata associated with the one or more first images with metadata associated with the one or more second images.

20. A non-transitory computer readable medium having instructions stored thereon that, when executed by a processing device, cause the processing device to perform one or more operations comprising:
receiving one or more first images;
processing the one or more first images to determine one or more aspects of an exterior of a vehicle;
receiving one or more second images;
processing the one or more second images with one or more images previously received with respect to the vehicle to determine one or more aspects of an interior of the vehicle;
validating the determined one or more aspects of the interior of the vehicle with respect to the determined one or more aspects of the exterior of a vehicle by determining that an odometer identified within the one or more second images is consistent with at least one of a make of the vehicle or a model of the vehicle identified with respect to the one or more first images; and
initiating one or more operations based on the validation.
